(19) United States
(12) Patent Application Publication
(10) Pub. No.: US 2002/0101167 A1
(43) Pub. Date: Aug. 1, 2002

(54) Capacitively coupled reactive ion etch plasma reactor with overhead high density plasma source for chamber dry cleaning

(75) Inventors: Hongqing Shan, Cupertino, CA (US); Mahmoud Dahimene, Sunnyvale, CA (US); Kenny L. Doan, San Jose, CA (US)

Correspondence Address: PATENT COUNSEL, APPLIED MATERIALS, INC., Legal Affairs Department, P.O. Box 450A, Santa Clara, CA, 95052, US

(73) Assignee: Applied Materials, Inc.

(21) Appl. No.: 09/967,812

(22) Filed: Sep. 28, 2001

Related U.S. Application Data
(60) Provisional application No. 60/258,088, filed on Dec. 22, 2000.

(51) Int. Cl. H05B 31/26

(52) U.S. Cl. 315/111.11

(57) ABSTRACT

A plasma reactor for processing a semiconductor workpiece, includes a vacuum chamber including a side wall and an overhead ceiling, a wafer support pedestal within the vacuum chamber, gas injection passages to the interior of the vacuum chamber coupled to a process gas supply, and a first RF power source for applying RF power to the wafer support pedestal for generating a capacitively coupled plasma. It further includes plural electromagnets near said chamber, and a time-varying current source connected to said plural electromagnets for producing a magnet field that rotates relative to said wafer pedestal. An inductive plasma source power applicator is provided near said chamber and a second RF power source is provided for applying RF power to said inductive plasma source power applicator for generating an inductively coupled plasma within said chamber.

### BACKGROUND OF THE INVENTION

Magnetically enhanced reactive ion etching of semiconductor wafers in plasma reactors is a well-known technique that enhances the uniformity of plasma ion distribution across the wafer surface. Generally, in carrying out this technique, a low or medium density plasma is formed in the reactor chamber by capacitive discharge between an RF-driven wafer support pedestal and the overlying ceiling The chamber is held at a low pressure as process gases are injected into the chamber interior. The low chamber pressure is maintained by pumping the injected process gases out of the chamber quickly. As a consequence, their molecules have a shorter residency time within the chamber. The process is magnetically enhanced by producing a rotating magnetic field in the chamber so as to cause the plasma to drift along the magnetic field lines in ever-changing directions which are predominantly parallel to the surface of the wafer. This causes the plasma to distribute evenly over time across the wafer surface. This can be accomplished by placing, for example, four electromagnets near the plane of the wafer but outside the chamber at 90 degree intervals, and driving them with a low frequency electric current which is phase-shifted at each magnet so that the magnets are driven in quadrature. Alternatively, the same effect can be provided by placing four permanent magnets on a table and rotating the table above or around the chamber.

When etching silicon dioxide overlying a silicon layer (which is not to be etched), etching of the underlying silicon layer (once it becomes partially exposed) is prevented by employing an etch process gas that dissociates into etchant species (fluorine-rich fluoro-hydrocarbon compounds) and polymer forming species (carbon-rich fluoro-hydrocarbon compounds). Such polymers in a plasma environment adhere to materials (e.g., silicon) that do not contain oxygen but are readily removed from oxygen-containing materials (e.g., silicon dioxide) by the plasma so that such materials remain exposed for etching. Thus, the use of fluoro-hydrocarbon process gases provides the requisite etch selectivity in silicon dioxide etch processes.

The shorter residency time of the process gas molecules referred to above enhances process selectivity in silicon dioxide etch processes because it limits the degree of dissociation of the process gas molecules in the plasma. This is because limiting the degree of dissociation of the fluoro-hydrocarbon species limits the formation of simpler fluorine-containing species, such as free fluorine. The simpler fluorine-containing species are such powerful etchants that, if allowed to form and predominate, they would reduce etch selectivity by attacking everything including protective polymer coatings and photoresist layers. Such control of dissociation achieved in low pressure capacitive discharge characteristic of MERIE reactors is evidenced by mass spectrometer measurements showing high concentrations of complex fluorine compounds (that tend to etch more controllably) and very low incidence of simple fluorine compounds (that tend to etch uncontrollably). Dissociation is limited not only by the short residency time of the lower pressure regime but also by the lower plasma density of the MERIE reactor and process.

The high selectivity performance of such a magnetically enhanced ion etch (MERIE) plasma reactor is required in the fabrication of small device geometries and particularly in those involving very high aspect ratio features (deep small diameter openings, for example). Therefore, this type of reactor appears to be a likely candidate for fabricating even smaller geometries and more difficult process tasks.

One difficulty that has arisen as device feature sizes continue to shrink with the general progress of the industry is particle contamination on the wafer. Since the MERIE reactor typically is not capable of producing a high density plasma, it is difficult to completely or uniformly clean off polymer deposits on the chamber walls between process runs. Thus, as polymer accumulated thereon, it tended to flake off and fall on the wafer. A related problem was that the chemistry in the plasma would change during processing of a wafer due to the accumulation of polymer on chamber surfaces that initially were clean, so that the reactor performance was not steady.

One solution to these problems was to run coolant through the chamber walls so that polymer accumulating thereon would be held firmly and not flake off over the processing of many wafers in the same chamber. Rather than attempt to clean the chamber walls in situ between production runs, the polymer would be allowed to accumulate, the result being that the walls were always covered with polymer so that reactor performance was more steady. Furthermore, since the walls were cooled, the polymer adhered strongly and would not flake off. The walls could be implemented as removable liners that could be replaced periodically with clean ones after a very thick build-up of polymer had been accumulated thereon.

The problem was that not all process recipes were compatible with this approach. For example, some process recipes might call for higher ion energies or other parameter changes that would tend to ablate deposited polymer off of the chamber walls despite the cooling of the walls. Thus, the avoidance of particle contamination required that the MERIE reactor be limited to only those processes compatible with the accumulation of polymer on the cooled chamber walls. This, of course, has limited the utility of the MERIE reactor.

From the foregoing, it would appear that the utility of an MERIE reactor is significantly limited. Such a reactor cannot be used continuously with successively different process recipes if one of the recipes employs process conditions that tend to cause flaking of the polymer previously accumulated on the chamber walls.

### SUMMARY OF THE INVENTION

A plasma reactor for processing a semiconductor workpiece, includes a vacuum chamber including a side wall and an overhead ceiling, a wafer support pedestal within the vacuum chamber, gas injection passages to the interior of the vacuum chamber coupled to a process gas supply, and a first RF power source for applying RF power between the wafer support pedestal and the ceiling for generating a capacitively coupled plasma. It further includes apparatus for producing a magnet field that rotates relative to the wafer pedestal. An inductive plasma source power applicator is provided within the chamber between the pedestal and the ceiling and a second RF power source applies RF power to the inductive plasma source power applicator for generating an inductively coupled plasma within the chamber.

One feature of the inductive plasma source power applicator is that it is apertured to provide a sufficiently large opening therethrough between the ceiling and the wafer support pedestal so as to allow (i.e., not block) efficient capacitive coupling of RF power to the chamber interior from the RF source connected between the ceiling and the pedestal. Specifically, the inductive plasma source power applicator is a conductor helically wound around a torroidal magnetically permeable core, the entire apparatus therefore defining a torus with a circular aperture in its center. This torus extends around the perimeter of the chamber and thereby leaves the center essentially unblocked and therefore avoids blocking capacitive coupling to the plasma of RF power applied between the pedestal and the ceiling.

The rotating magnetic field-producing apparatus may be a plurality of electromagnets excited by different phases of a sinusoidally time-varying current that lie in a plane parallel to a working surface of the wafer pedestal whereby to circulate, across the working surface, plasma produced by one of: (a) capacitive coupling of RF power from the wafer pedestal, (b) inductive coupling from the inductive plasma source power applicator. Alternatively, the rotating magnetic field-producing apparatus may be a set of permanent magnets on a rotating table adjacent the chamber.

An optically transmissive window lies in either the side wall or in the ceiling. An optical detector views the interior of the chamber through the window. A process controller has a control output to at least one of the first and second RF power sources and an input sensing a response of the optical detector, the controller being programmed to produce control signals on the output in accordance with the response of the optical detector.

A method of operating a plasma reactor includes cleaning the interior of the reactor by supplying a cleaning gas into the reactor, producing a high density inductively coupled RF plasma in the reactor and circulating the high density plasma within the chamber by inducing a magnetic field that circulates about the chamber at a low frequency. The method the proceeds by processing a wafer within the chamber by supplying a process gas into the reactor, producing a low density capacitively coupled RF plasma in the reactor and circulating the low density plasma within the chamber by inducing a magnetic field that circulates about the chamber at a low frequency.

The process gas contains a polymer precuror species, and the step of processing a wafer further includes selecting chamber parameters so that the reactor operates in an evaporation mode in which polymer is removed from interior chamber surfaces faster than it is deposited.

### BRIEF DESCRIPTION OF THE DRAWINGS

FIG. 1 depicts a first embodiment of the invention.

FIG. 2 illustrates a torroidal core and multiple windings in accordance with an aspect of the invention.

FIG. 3 is a cross-sectional view of the torroidal core within its housing.

FIG. 4 is a plan view of the inductive source illustrating the provision of external utilities to the core within the chamber.

FIGS. 5 and 6 illustrate different embodiment of a spacer below the overhead inductive source for controlling plasma ion density near the center of the chamber.

FIG. 7 is a graph illustrating a signature of a detector output employed in carrying out a method of the invention for end point detection.

FIG. 8 illustrates a control system for carrying out a method of the invention.

FIG. 9 illustrates an embodiment employing a removable gas distribution liner at the chamber ceiling.

FIG. 10 illustrates an embodiment corresponding to FIG. 9 but with a different implementation of the liner.

FIG. 11 illustrates a modification of the embodiment of FIG. 10.

### DETAILED DESCRIPTION

### Overview

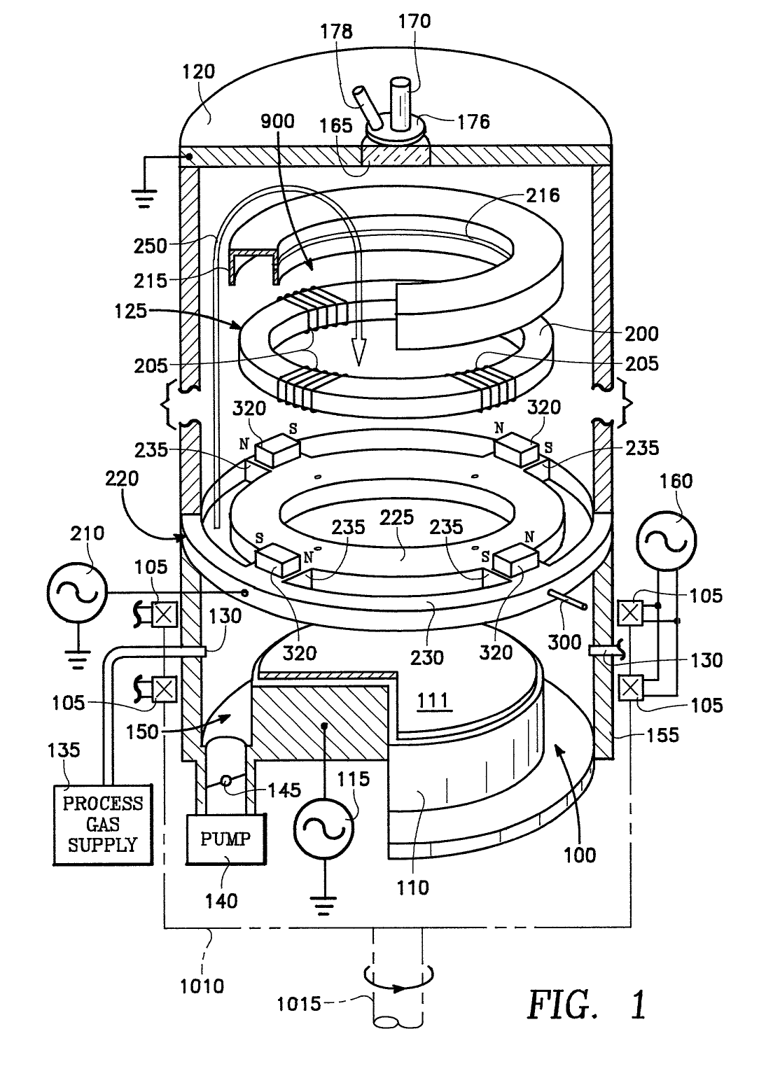

FIG. 1 depicts an embodiment illustrative of the concept of the invention. An MERIE reactor includes a vacuum chamber 100, MERIE magnets 105 around the periphery of the chamber 100 and a wafer support pedestal 110 driven by an RF power source 115, the chamber 100 including a ceiling or lid 120 that is grounded and therefore is a counter electrode to the RF-driven pedestal 110. The wafer support pedestal 110 functions as an electrode to maintain a capacitively coupled plasma having a low to medium ion density, e.g., an ion density of about 10E9 ions per cubic centimeter. Such a plasma is suitable for wafer processing such as etch processing with a high etch selectivity characteristic of low pressure MERIE processes. The reactor further includes an overhead inductive source power applicator 125 below the ceiling 120. The inductive plasma source power applicator 125 is capable of maintaining an inductively coupled plasma in the chamber 100 having a high ion density, e.g., an ion density of about 10E11 ions per cubic centimeter, or greater. Such a high density plasma is particularly suitable for efficiently removing polymer from interior chamber surfaces prior to placing a wafer 111 on the support pedestal 110 for MERIE processing. Preferably, during such a dry clean operation, a cleaning gas, such as a fluorine containing species is introduced, and the MERIE magnets 105 are activated in the same manner as they are during conventional MERIE processing so that the high density plasma created by the inductive RF power applicator 125 is circulated azimuthally within the chamber 100 to create a highly uniform high density plasma. The result is that the interior surfaces within the chamber 100 are cleaned (freed of polymer deposits) very quickly by the high density plasma in a highly uniform and efficient manner that hitherto has not been possible.

One advantage is that the chamber 100 can now be reliably cleaned very quickly by a high density plasma before processing each wafer 111 (if desired) or each small series of wafers, so that it may be operated in “polymer removal” mode, in which the chamber walls are maintained at a sufficiently high temperature during wafer processing to keep them free of polymer accumulation. A further advantage that follows this feature is that by thus keeping the chamber interior surfaces clean, a window provided through the ceiling will not be blocked by opaque polymer deposits. Therefore, an optical detector facing the window may be employed to continuously monitor a parameter such as silicon oxide thickness during MERIE etch processing. Thus, an MERIE reactor employing such an optical detector is capable of performing partial silicon oxide etch processes (which must be halted after leaving a predetermined silicon oxide thickness unetched), a significant advantage. An even further advantage is that the chamber cleaning process (employing the inductive power applicator 125) may be optimized using a method disclosed below in the present specification. In this method, cleaning gases are introduced into the chamber 100 and the inductive power applicator 125 and the MERIE magnets 105 are turned on until the occurrence of a certain signal signature from the optical detector. This signature corresponds to a definitive dip in the detected optical intensity, and corresponds to an ideal time for terminating the chamber clean process with the inductive RF power applicator 125.

### Structural Features of a First Embodiment

Referring again to FIG. 1, the MERIE reactor includes an array of gas inlet nozzles 130 coupled to a process gas supply 135 and a vacuum pump 140 coupled via a butterfly valve 145 to a pumping annulus 150 defined between the wafer support pedestal 110 and a cylindrical side wall 155 of the chamber 100. A low frequency sinusoidally varying current source 160 is coupled to the MERIE electromagnets 105. As described above, different ones of the magnets 105 may receive a particular phase of the current from the current source 160 so that the combination of all the MERIE magnets 105 produces a magnetic field that rotates in a plane parallel with that of the top surface of the wafer support pedestal 110 at the frequency of the current source 160.

Alternatively, another way of generating a rotating magnetic field is to provide each of the MERIE magnets 105 as a permanent magnet (rather than as an electromagnet), all of them mounted on a support structure or table 1010 (dashed line) that is rotated by a rotator 1015 (dashed line). In this case, the sinusoidal current source 160 is not present.

An optically transparent window 165 is provided in the ceiling 120, and an optical detector 170 views the interior of the chamber 100 through the window 165. A radiation source 178 furnishes light through the window 165 into the chamber interior. The window 165 is made of suitable material such as sapphire, alumina or other suitable ceramic capable of withstanding exposure to plasma and process gases in the chamber interior. The detector 170 and the radiation source 178 may be employed together to monitor the thickness of a film or layer being etched on a workpiece or wafer 111 supported on the pedestal 110. A polarizer 176 may be placed before the detector 170 and the radiation source 178, respectively.

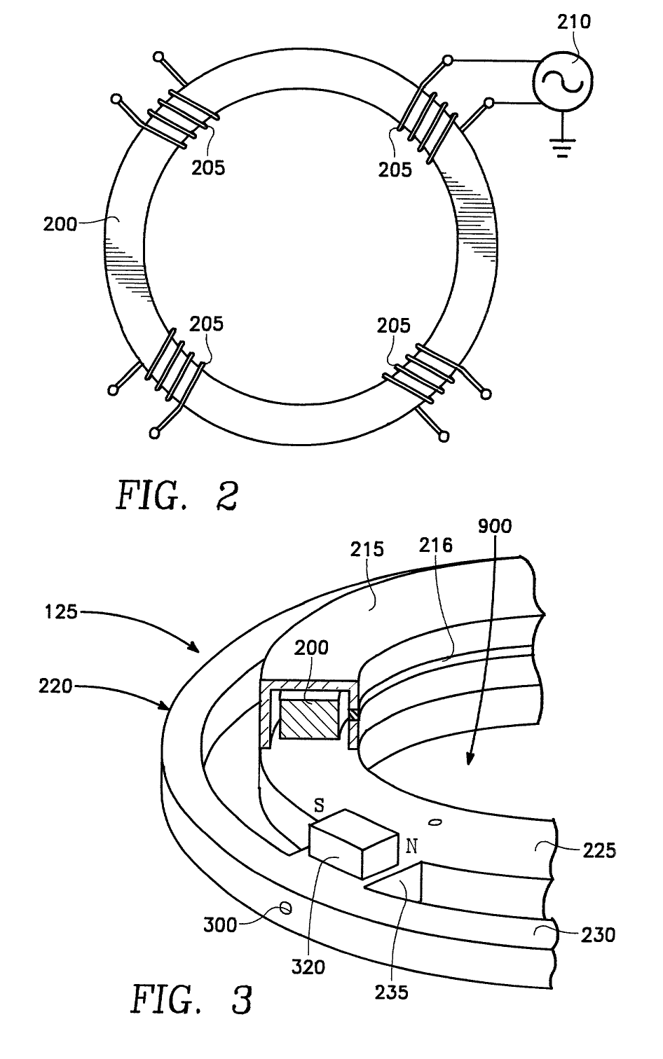

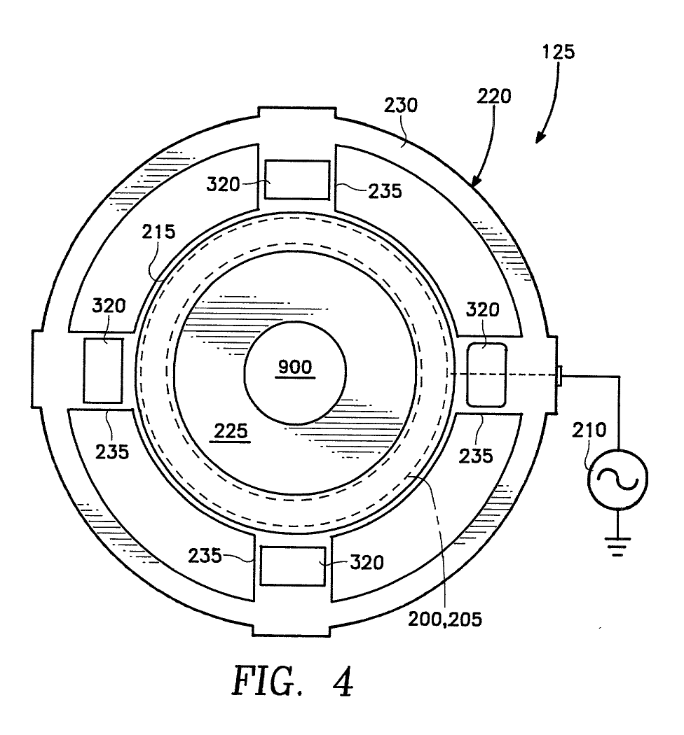

In the embodiment of FIG. 1, the inductive power applicator 125 is a torroidal magnetic core 200 residing within the vacuum chamber 100 and driven by multiple windings 205 coupled to an RF power source 210 (FIG. 2). In order to protect the magnetic core 200 from the plasma and gases in the chamber 100, the magnetic core 200 is enclosed between an upper torroidal housing 215 and a lower base 220, as shown in FIGS. 1, 2, 3 and 4. The lower base 220 has an inner support annulus 225 that mates with the upper housing 215 to enclose the torroidal core 200, an outer ring 230 resting on top of the cylindrical side wall 155 and radial support legs 235 connecting the inner support annulus 225 to the outer ring 230. Preferably, the upper housing 215 and the lower base 220 are formed of anodized aluminum. The voids between the inner annulus 225 and the outer ring 230 as well as the center void surrounded by the torroidal upper housing 215 permit plasma to circulate around the interior and exterior of the torroidal source 125, as indicated by the path arrow 250. The torroidal source 125 is particularly efficient because the inductive core 200 and windings 205 are entirely surrounded by the plasma in the chamber 100. A gap 216 filled by an insulating material extends around the upper housing 215 and prevents induction currents from forming in the housing 215 that would otherwise interfere with inductive coupling from the core 200 to the interior of the chamber 100.

The windings 205 are connected to the RF power source 210 through conductors extending through the radial legs 235, so that the conductors are protected from attack from the harsh environment of the chamber interior. The temperature of the upper housing 215 and the lower base 220 is controlled by providing fluid passages 300 from the side wall 155 through the radial legs 235, through the lower annulus 225 and through the upper housing 215. A fluid for cooling or heating these members is pumped through the fluid passages.

The concept of a torroidal inductive source inside the reactor chamber has been suggested as in U.S. Pat. No. 5,998,933. However, there is no concept of using such a source in conjunction with a capacitively coupled source driven between the pedestal and ceiling, nor any suggestion about the optimum area of the aperture within the torus to optimize capacitive coupling of the RF power applied between the ceiling and pedestal. Moreover, since there was no concern with introducing conductors in the region between the ceiling and the pedestal (where the present invention seeks to provide capacitive coupling of RF power), such torroidal sources were powered through the ceiling rather than through the side walls as in the present invention.

### Enhancing Plasma Distribution Uniformity

Several features combined together in the embodiment of FIG. 1 assure uniform distribution of the plasma within the chamber both azimuthally and radially. First, four coil windings 205 are placed at four locations on the torroidal coil 200 spaced apart at even (90 degree) intervals. This enhances the symmetry of the current induced in the plasma by current in the windings 205.

Secondly, the torroidal core 200 induces an azimuthal magnetic field that enhances the uniformity of the azimuthal distribution of the plasma within the chamber 100.

Third, in order to further enhance the uniformity azimuthal plasma distribution, permanent magnets 320 are placed on each radial leg 235, the north-south polar orientation of each magnet 320 being azimuthal. Each permanent magnet 320 compensates for the blockage by the radial leg 235 of the annular gap between the inner annulus 225 and the outer ring 230. Without the permanent magnets 320, the azimuthal circulation of plasma through the gap between the inner annulus 225 and the outer ring 230 would be interrupted by the radial legs 235. With the permanent magnets 320, azimuthal flow of plasma around the torroidal source 125 is enhanced.

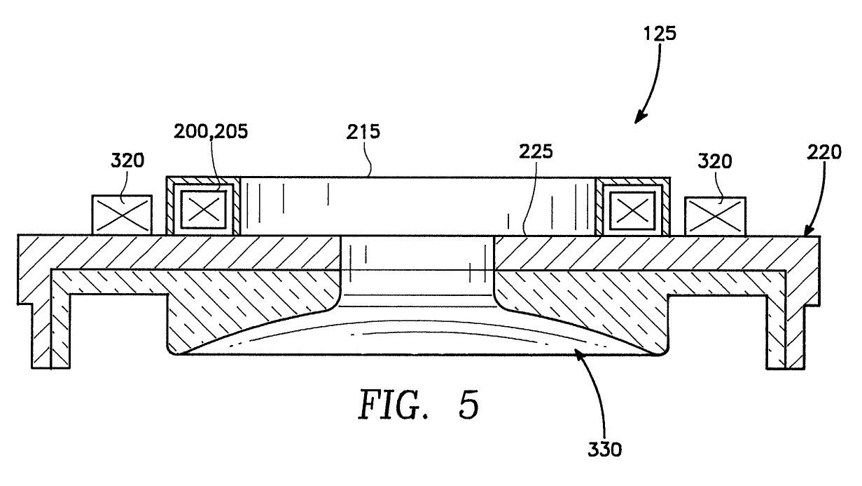

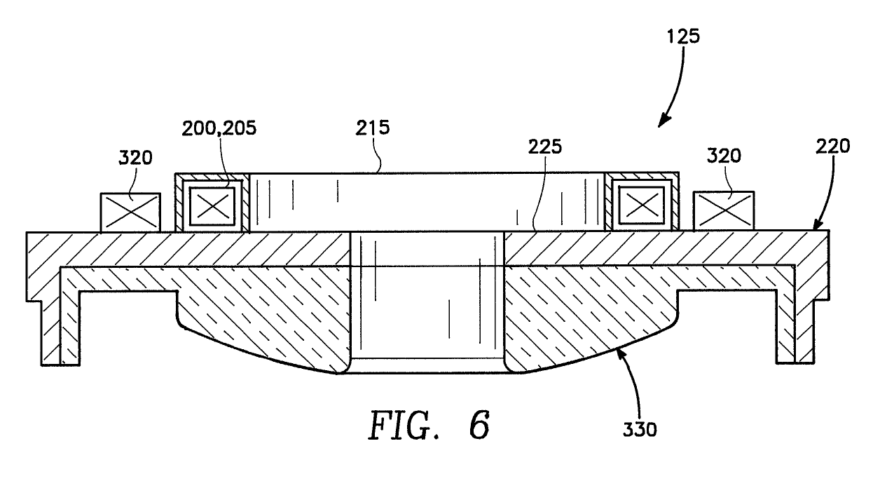

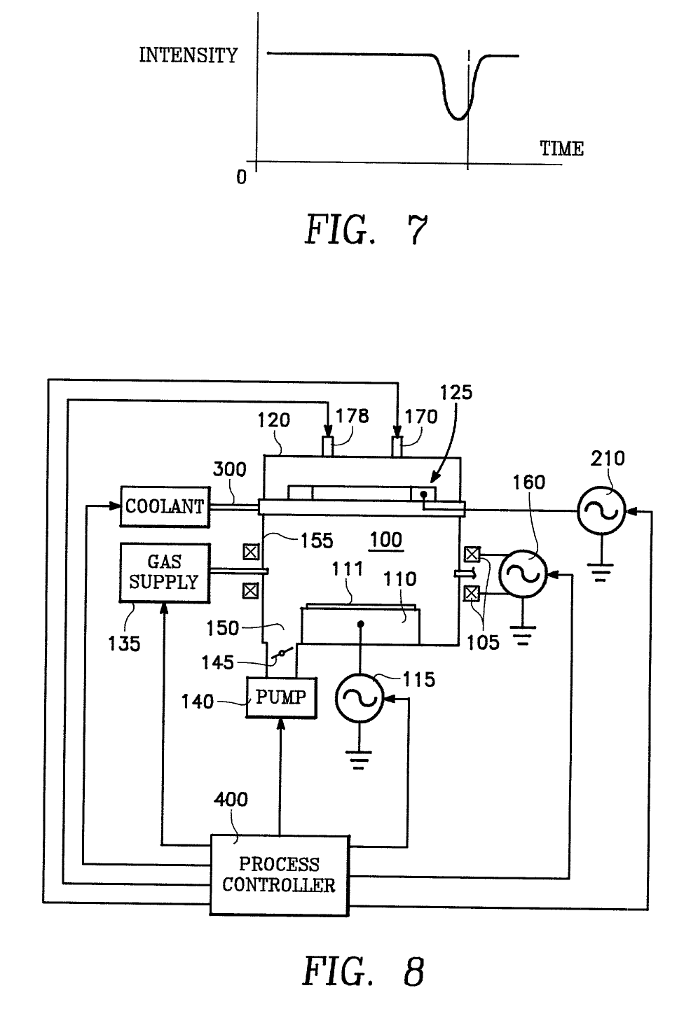

Fourth, uniformity of radial plasma distribution across the surface of the wafer 111 is enhanced by providing, as shown in FIG. 5, a shaped liner 330 on the bottom surface of the lower base 220, which is a discrete removable member (as illustrated). Alternatively, the liner 330 may be integrally formed with the lower base 220. The liner 330 may be concave (center high) as in FIG. 5, but is preferably convex (center low) as shown in FIG. 6. The shape of the convex (center low) liner 330 reduces the average volume over the center of the wafer 111 in order to compensate for the tendency of the inductive plasma source 125 to produce a radial plasma distribution that is largest at the center and less toward the edge of the wafer 111. By reducing the wafer-to-base spacing near the wafer center (by introducing the liner 330), plasma density over the wafer center is reduced. The liner 330 is annular so that it does not block plasma flow through the center of the torroidal source 125. The vertical cross-sectional shape of the liner 330 is thus selected to achieve the ideal suppression of plasma density over the wafer center so that radial plasma distribution has the greatest possible uniformity.

Fifth, the MERIE magnets 105, activated while the inductive source 125 generates a high density plasma, produce a magnetic field that circulates in a direction parallel to the plane of the wafer 111, as referred to previously in this specification. The plasma ions tend to drift along the lines of this circulating magnetic field, so that they swirl in an azimuthal direction. This feature enhances the uniformity of the plasma distribution both azimuthally and radially.

### End-Point Detection for the Cleaning Process

As briefly referred to earlier in this specification, the optical detector 170 can be employed to precisely determine the optimum time for terminating the high density plasma cleaning process.

During MERIE processing of a production wafer, which may include, for example, a silicon dioxide etch operation in accordance with a specified process recipe, process gases such as fluoro-hydrocarbon gases are injected into the chamber 100 at a gas flow rate specified by the process recipe, the vacuum pump 140 is controlled to achieve the chamber pressure specified by the process recipe, and the RF generator 115 is controlled to produce the RF power specified by the process recipe. Simultaneously, in the exemplary embodiment, the overhead inductive source 125 is inactive.

Later, when the chamber 100 is to be cleaned, there is no wafer on the wafer support pedestal 110. Cleaning gases containing Fluorine but free of any polymer precursor species are introduced into the chamber 100. The RF source 210 supplies sufficient power (e.g., 4000 Watts) to the inductive RF power applicator 125 to produce a high density plasma, while MERIE magnets 105 are active and cause the high density plasma to circulate in the chamber 100 for greater uniformity. Meanwhile, the output of the optical detector 170 is monitored during the cleaning operation.

The optical intensity remains fairly stable during most of the process, and when the cleaning process reaches an ideal point for termination, the intensity dips precipitously for a brief period. This is illustrated in FIG. 7. Sometime during this brief period, the cleaning process is terminated by turning off the RF source 210 and removing the cleaning gases. This can be done automatically by a process controller 400 whose connection to the reactor of FIG. 1 is illustrated in FIG. 8.

In FIG. 8, the controller 400 receives the output of the detector 170. The controller is programmed to recognize the occurrence of the brief dip in intensity illustrated in FIG. 7, and to turn off the RF source 210 and stop the introduction of the cleaning gases into the chamber 100. As described in the referenced application, this dip can be characterized by a duration falling within a predetermined range of times and an amplitude excursion falling within a predetermined range or threshold. The process controller 400 may be programmed to require a certain range of duration and a certain range of amplitude excursion. The same process controller 400 may also be employed to control all of the process parameters during wafer processing, including RF power from the generator 115, chamber pressure, process gas flow rate and so forth. It may further be enabled to monitor an etched layer thickness on the wafer 111, and may be further programmed terminate an etch process whenever a desired thickness has been reached, for example.

The controller 400 is preferably a programmable computer with a mass memory storing various programs for implementing different plasma processes and chamber cleaning procedures. Its outputs may control the vacuum pump 140! the gas supply 135, the RF power source 11S, the RF power source 210, the low frequency current source 160 and the radiation source 178. Its inputs are coupled to the optical detector 170, a pressure sensor in the chamber (not shown in the drawing) and other sensors that may be provided.

### Features of the Liner 330

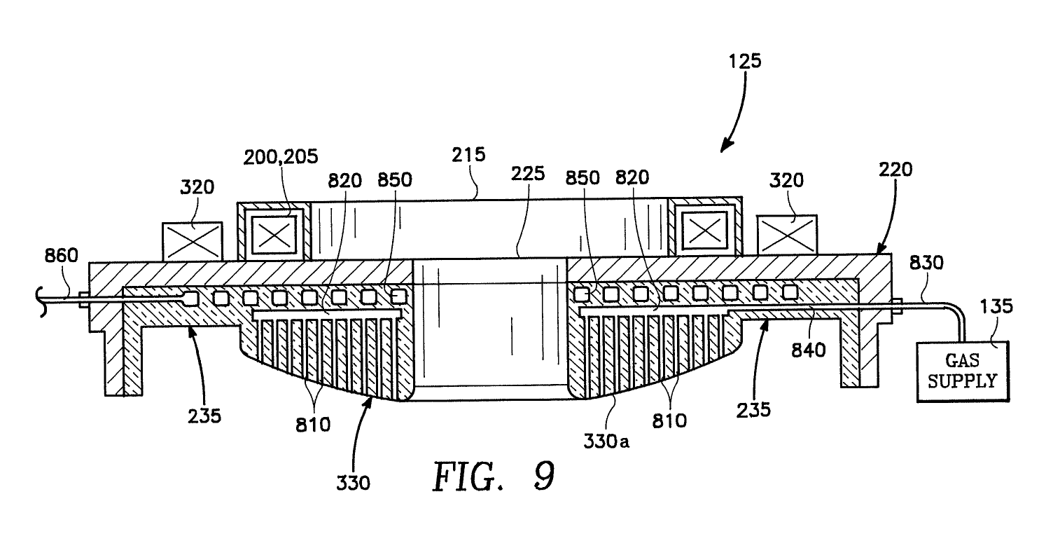

The liner 330 of FIG. 6 may be in the form of a gas distribution plate as illustrated in FIG. 9. For this purpose, the gas distribution plate liner 330 of FIG. 9 has a large array of gas distribution orifices 810 with their openings in the bottom surface 330a of the liner 330. A gas manifold 820 formed within the liner 330 feeds gas to each of the orifices 810 and is itself supplied with process gas by a gas feed line 830 connected to the bottom base 220. The bottom base 220 has a gas feed line 840 extending through one of the radial legs 235 to the process gas supply 135, so that the process gas is fed from the side to the gas distribution orifices 810. In the embodiment of FIG. 9, the inductive source 125 is integrated with a gas distribution plate or showerhead consisting of the array of gas distribution orifices 810.

The liner 330 also has coolant passages 850 formed within it, the coolant passages 850 being connected to a coolant supply conduit 860 formed within the liner 330. The coolant supply conduit 860 is connected through one of the radial legs 235 to a coolant source (not shown). Feeding utilities such as the coolant jackets and the gas distribution orifices from the side (through one of the radial legs 235) avoids introducing additional structural elements into the processing region of the chamber, thus minimizing interference with the electric field between the ceiling and wafer pedestal.

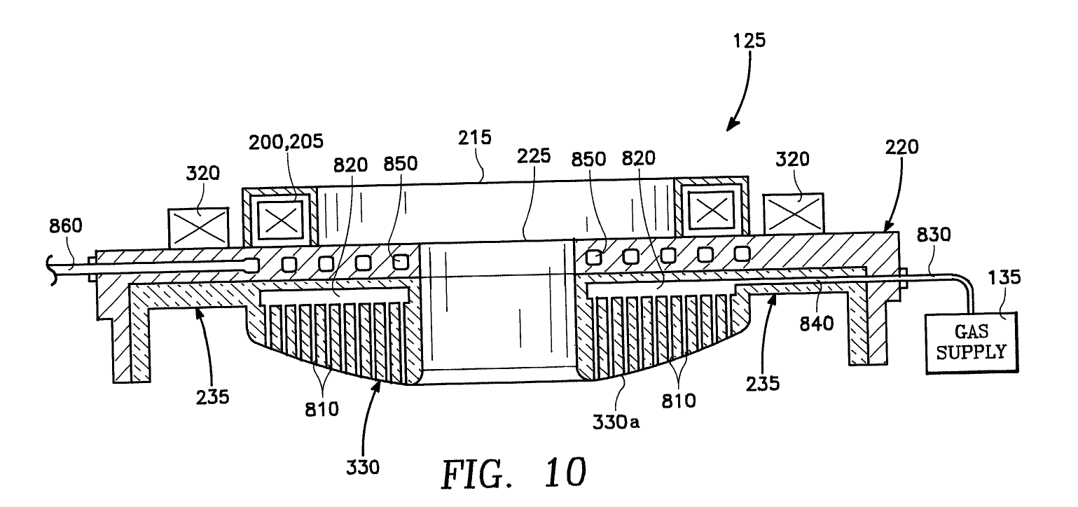

FIG. 10 illustrates a modification of the embodiment of FIG. 9 in which the coolant passages 805 are formed in the ceiling 120 rather than in the liner 330.

The gas distribution plate/liner 330 of FIG. 9, the base 220, the upper housing 215 and the torroidal core 200 may all be assembled together as a unit for installation in the reactor.

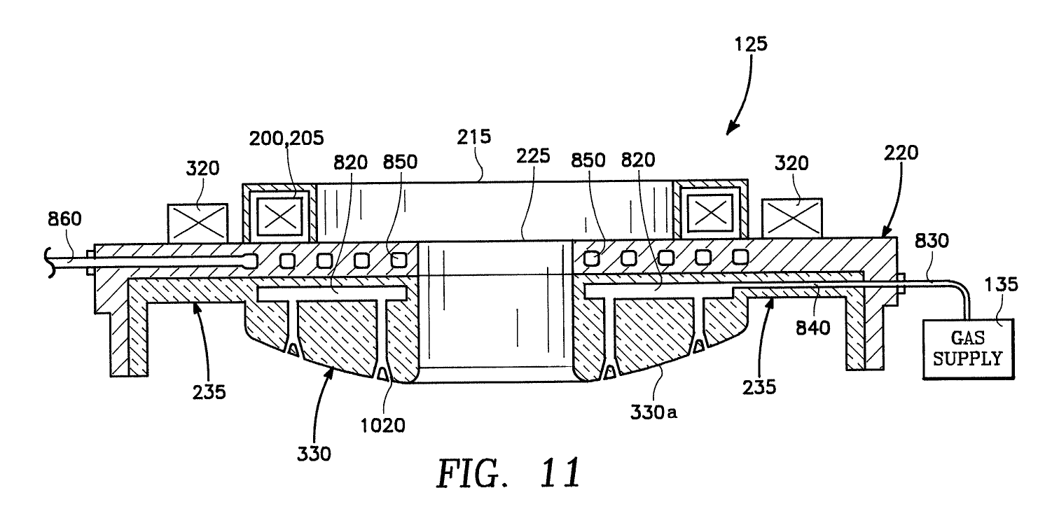

FIG. 11 illustrates another modification in which the showerhead assembly of FIG. 10 has an array of gas injectors 1020 opening to the chamber.

### How the Inductive Source is Compatible with the Capacitive Source

As referred to above, capacitive coupling to the plasma within the chamber is achieved by connecting the RF power source 115 between the wafer pedestal 110 and the ceiling 120. The inductive source 125 lies between the ceiling 120 and the pedestal 110 and yet does not block the electric field formed by the RF power applied between the ceiling 120 and the pedestal 110. This is because the inductive source 125 is formed as a torus having an aperture 900 (FIG. 1) in its center through which electric field lines may freely extend from the ceiling 120 to the pedestal 110 (and vice versa). Thus, we have discovered that with the aperture 900, the inductive source 125 may be placed between the two “plates” of the capacitive source (i.e., the ceiling 120 and the pedestal 110) without blocking the capacitive source, a significant advantage.

Alternative Modes of Use

While the present invention is directed primarily toward removing limitations on the use of a capacitively coupled MERIE plasma reactor, it may be operated in another mode. Specifically, it is possible to perform certain wafer processes using a high density plasma. In such a case, during wafer processing, the torroidal inductive source 125 would be active and the plasma used to process the wafer 111 (e.g., to perform an etch process or a chemical vapor deposition process) would be a high density inductively coupled plasma. In this case, various plasma process parameters would be adapted to high density plasma processing, such as a higher chamber pressure for example. The RF power applied by the RF source 115 to the wafer support pedestal 110 would primarily control the ion energy at the wafer surface, while the plasma ion density would be controlled independently by the RF power source 215 applied to the inductive RF power applicator 125.

### Exemplary Implementation

In carrying out the embodiment of FIG. 1, the skilled worker can choose essential parameters for carrying out a particular process. In one implementation carried out by the inventors herein, material for the core 200 was selected having a relative magnetic permeability of 2400. In this implementation, the permanent magnets 320 had a strength in the range of 30-200 Gauss, the current source 160 for the MERIE magnet 105 had a frequency of 0.25 Hz, and the RF source 210 used during chamber cleaning produced a frequency of 400 kHz and a power level in the range of 4000 Watts for a chamber size adapted to accommodate 200 mm wafers. The cleaning process is terminated as soon as the output from the optical detector 170 exhibits the characteristic dip illustrated in FIG. 7. During chamber cleaning, the chamber pressure was maintained between 50 and 100 Torr, while the cleaning gas flow rate into the chamber was 100 sccm. During wafer processing, the reactor is operated in conventional mode for MERIE plasma processing. For example, the chamber pressure is maintained at 40 Torr, C4F6 process gas is supplied into the chamber 100 at a flow rate of between 200 and 800 sccm, the MERIE magnets 105 are supplied with a current at 0.25

Hz, and the RF source 115 applies 1800 Watts of power to the inductive RF power applicator 125 at frequency of 13.56 MHz for a 200 mm wafer. If a partial etch process is being performed, then the etch process is terminated when measurements using the optical detector 170 indicate the layer being etched has been reduced to a predetermined thickness.

### Applications of the Invention

In conclusion, an MERIE plasma reactor exhibits superior etch selectivity due at least in part to its ability to limit dissociation of fluoro-hydrocarbon process gases. The invention expands the use of this valuable reactor to many processes beyond its conventional capability. Specifically, with the invention the MERIE reactor can be used in plasma processing regimes that tend to evaporate polymer from interior chamber surfaces. This is because with the invention the chamber need not be operated in a cooled polymer deposition mode to avoid contamination from polymer flaking, since in the invention the chamber is thoroughly cleaned prior to processing by the high density inductive plasma source. Thus, the reactor may be used to implement processes having, for example, higher ion energies that tend to prevent polymer deposition, so that the useful process window for the reactor is greatly expanded and the reactor can be operated in the clean (non-deposition) mode, a significant advantage. However, if desired, the reactor may be operated in a deposition mode.

As a further advantage, the invention also expands the use of this valuable reactor to partial etch processes in which a small portion or bottom fraction of a silicon dioxide layer is to be left in place at the conclusion of a silicon dioxide etch process. This is now practical because the invention permits the reactor to be operated in the polymer evaporation mode, in which the chamber surfaces are kept fairly clear of polymer accumulation or deposits. This feature ensures that an optical detector employed to measure the thickness of the layer being etched is enabled to view the wafer through a window in the chamber wall or ceiling since no opaque polymer layer is allowed to accumulate which would other block the view. As a result, the etch process may be controlled in accordance with layer thickness measurements from the detector, and terminated as soon as the silicon oxide layer reaches the desired thickness. This further expands the useful process window of the MERIE reactor.

By thus enabling the use of an optical detector, the chamber cleaning process employing the high density plasma source can be monitored to determine when the chamber cleaning is complete, a significant advantage. Specifically, a brief temporal dip in the intensity measured by the detector signals the completion of chamber cleaning, so that the chamber cleaning process need be carried out no longer than necessary. Accordingly, all the features of the invention cooperate together to vastly improve the versatility and efficiency of the MERIE reactor.

The use of an RF-driven torroidal magnetic core 200 as the high density plasma source has the advantage of cooperating with the azimuthal circulation of the plasma by the MERIE magnets 105. Specifically, the windings 205 around the torroidal core 200 have radial current flow and therefore induce azimuthal lines of magnetic force. The plasma ions tend to drift along these azimuthal lines of magnetic force. The azimuthal circulation motion thus imparted to the plasma by the torroidal source 125 assists the MERIE magnets 105 that impart the same type of motion to the plasma. Specifically, the MERIE magnets produce sinusoidally varying magnetic fields that are phase-shifted relative to one another to produce a circulating magnetic field. They lie in a plane parallel to the plane of the wafer so that the circulating magnetic field is azimuthal, which the plasma ions follow. Thus, the azimuthal plasma circulation by the MERIE magnets 105 that improves plasma uniformity is supplemented by the azimuthal field of the torroidal core 200. This action is further enhanced by the provision of each azmuthally polarized permanent magnet 320 near a radial leg 235. The permanent magnets enhance the azimuthal plasma circulation despite any impediment to such circulation presented by the radial legs 235.

It is preferable to periodically clean the reactor chamber interior, for example cleaning it after a predetermined number of wafers has been processed in the reactor. This number may be as large as 100 to 200 wafers or as small as a few wafers. The objective of such periodic cleaning is to have the selectivity and stability of the polymer deposition mode of operation, while at the same time having predictable and steady low particle contamination performance, as well as an optimum or maximum mean number of wafers processed between chamber cleaning operations.

The upper inductively coupled RF power applicator 125 may be employed not only for chamber cleaning operations, but may, in addition, be employed during wafer processing simultaneously with the capacitively coupled RF power applicator (i.e., the RF-driven pedestal 110). Such simultaneous operation improves plasma ion distribution uniformity, etch rate and etch profile control. The inductively coupled RF power applicator 125 complements the operation of the capacitively coupled RF power applicator 110 because it provides more dissociation of plasma species to remove polymer at various features on the semiconductor wafer, such as contacts, via holes and trench necks.

The invention may be applicable in situations in which the wafer process is not an etch process but rather a plasma-assisted deposition process or chemical vapor deposition process. In this case, the optical detector 170 could monitor the thickness of the layer being deposited, so that the process may be halted after reaching the desired thickness.

While the invention has been described with reference to applications in MERIE reactors, it is applicable more generally to capacitively coupled reactors whether magnetically enhanced or not.

While the invention has been described in detail by specific reference to preferred embodiments, it is understood that variations and modifications thereof may be made without departing from the true spirit and scope of the invention.

What is claimed is:

1. A plasma reactor for processing a semiconductor workpiece, comprising:
a vacuum chamber including a side wall and an overhead ceiling, a wafer support pedestal within the vacuum chamber, gas injection passages to the interior of the vacuum chamber coupled to a process gas supply;
a capacitive plasma source power applicator comprising a first RF power source connected between the wafer support pedestal and the ceiling; and
an inductive plasma source power applicator within said chamber between said ceiling and said pedestal, and a second RF power source for applying RF power to said inductive plasma source power applicator, said inductive plasma source having an aperture therein that permits electric field lines to extend freely therethrough between said ceiling and said pedestal, whereby to avoid blocking said capacitive plasma source power applicator.

2. The apparatus of claim 1 further comprising a magnetic field generator capable of producing a magnetic field that rotates relative to said wafer pedestal, wherein said rotating magnetic field rotates generally in a plane parallel to a working surface of said wafer pedestal whereby to circulate, across said working surface, plasma produced by one of: (a) capacitive coupling of RF power from said wafer pedestal, (b) inductive coupling from said inductive plasma source power applicator.

3. The apparatus of claim 1 further comprising:
an optically transmissive window in one of said side wall and ceiling;
an optical detector viewing the interior of said chamber through said window.

4. The apparatus of claim 3 further comprising a process controller having a control output to at least one of said first and second RF power sources and an input sensing a response of said optical detector, said controller being programmed to produce control signals on said output in accordance with the response of said optical detector.

5. The apparatus of claim 4 wherein said process controller controls both said first and second RF power sources and is programmed to activate said first power source during etch processing of a wafer held on said support pedestal and to activate to said second power source during chamber cleaning.

6. The apparatus of claim 5 wherein said controller is further programmed to sense process end point from a signal produced by said optical detector during said etch process and to deactivate said first power source upon said end point being reached.

7. The apparatus of claim 6 wherein said controller is programmed deactivate said second power source during chamber cleaning after a signal produced by said optical detector exhibits a predetermined signature.

8. The apparatus of claim 8 wherein said predetermined signature is a temporally brief decrease in the amplitude of a signal produced by said optical detector.

9. The apparatus of claim 1 wherein said inductive plasma source power applicator comprises a torroidal magnetic core and at least one primary winding around a portion of said core connected to said second power source.

10. The apparatus of claim 1 wherein said inductive source power applicator comprises a helical coil antenna connected to said second power source.

11. The apparatus of claim 9 wherein said torroidal core is inside said chamber, said apparatus further comprising:
a support housing around said torroidal core for supporting said torroidal core and protecting said core from plasma in said chamber.

12. The apparatus of claim 11 wherein said pedestal is adapted to hold a wafer facing said ceiling, and wherein said support housing holds said torroidal core between said pedestal and said ceiling so that the rotational axis of symmetry of said torroidal core at least roughly coincides with the axis of symmetry of said pedestal.

13. The apparatus of claim 12 wherein said support housing comprises:
(I) a base plate comprising:
(A) an inner annulus underlying said torroidal core,
(B) an outer annulus supported by said side wall and radially spaced from said inner annulus to form an azimuthally extending gap therebetween,
(C) plural radial legs connected between said inner annulus and outer annulus; and
(II) an upper housing surrounding side and top surfaces of said torroidal core and resting on said inner annulus of said base plate, said upper housing and said inner annulus together forming a torroidal housing surrounding said torroidal core.

14. The apparatus of claim 13 wherein said azimuthally extending gap extends generally in a circular direction of a magnetic field induced by said torroidal magnetic core, said apparatus further comprising:
permanent magnets adjacent respective ones of said radial legs and having their poles aligned azimuthally so as to azimuthal circulation of plasma through said azimuthally extending gap between said inner and outer annuli.

15. The apparatus of claim 13 wherein said support housing comprises a conductive material.

16. The apparatus of claim 15 wherein said conductive material comprises anodized aluminum.

17. The apparatus of claim 13 further comprising internal passageways through said radial legs and conductors connecting said winding around said torroidal core to said second RF power source.

18. The apparatus of claim 17 further comprising thermally conductive fluid passages within said inner and outer annuli connected by passages within said radial legs.

19. The apparatus of claim 13 further comprising plural sets of windings around said torroidal core connected to said second RF power source, the sets windings being equally spaced and being connected to said second power source by conductors passing through the passages in said radial legs.

20. The apparatus of claim 19 wherein there are four of said radial legs and there are four sets of windings around said core.

21. The apparatus of claim 19 further comprising permanent magnets adjacent respective ones of said radial legs and having their poles aligned azimuthally so as to promote plasma flow within a space between said inner and outer annuli of said support housing.

22. The apparatus of claim 13 wherein said torroidal housing has a center passageway therethrough whereby plasma in said chamber is able to circulate between said azimuthally extending gap and said center passageway.

23. The apparatus of claim 13 wherein at least a portion of said base plate extends partially downwardly toward said wafer support pedestal to define a reduced volume over said wafer pedestal and a corresponding pedestal-to-base plate gap length.

24. The apparatus of claim 23 wherein said gap length is sufficiently small to improve radial plasma ion distribution uniformity to reducing plasma ion density over a center portion of said wafer support pedestal.

25. The apparatus of claim 23 wherein said base plate has an annular bottom surface facing said wafer support pedestal and defining said gap length, said bottom surface having a three-dimensional shape.

26. The apparatus of claim 25 wherein said bottom surface is center high.

27. The apparatus of claim 25 wherein said bottom surface is center low.

28. The apparatus of claim 25 wherein said inductive source power applicator comprises a helical coil antenna connected to said second power source.

29. The apparatus of claim 28 wherein said helical coil antenna comprises a solenoidally shaped conductor.

30. The apparatus of claim 28 wherein said helical coil antenna is dome-shaped.

31. A plasma reactor for processing a semiconductor wafer comprising a vacuum chamber for containing process gases and the semiconductor wafer, a capacitive RF power applicator having a pair of electrodes and a wafer support pedestal lying therebetween, and an inductive RF power applicator between said pair of electrodes having at least an aperture therein for permitting capacitive coupling between said pair of electrodes, said capacitive and inductive power applicators being separately controllable.

32. The apparatus of claim 31 further comprising MERIE magnets capable of producing a circulating magnetic field within the chamber, said MERIE magnets being operable with each of said capacitive and inductive RF power applicators wherein said capacitive RF power applicator is capable of maintaining a low to medium density plasma in said chamber circulated by said circulating magnetic field of said MERIE magnets and said inductive power applicator is capable of maintaining a high density plasma in said chamber circulated by the circulating magnetic field of said MERIE magnets.

33. A method of operating a plasma reactor, comprising:
cleaning the interior of said reactor by supplying a cleaning gas into said reactor, producing a high density inductively coupled RF plasma in the reactor and circulating the high density plasma within the chamber by inducing a magnetic field that circulates about the chamber at a low frequency;
processing a wafer within the chamber by supplying a process gas into said reactor, producing a low density capacitively coupled RF plasma in the reactor and circulating the low density plasma within the chamber by inducing a magnetic field that circulates about the chamber at a low frequency.

34. The method of claim 33 wherein the process gas contains a polymer precuror species, and the step of processing a wafer further includes selecting chamber parameters so that the reactor operates in an evaporation mode in which polymer is removed from interior chamber surfaces.

35. The method of claim 34 wherein said chamber parameters include at least one of: ion energy, chamber pressure, temperature of interior chamber surfaces.

36. The method of claim 33 wherein the step of processing a wafer further includes enhancing etch selectivity by reducing residency time of process gases in the reactor.

37. The method of claim 36 wherein the step of reducing the residency time comprises maintaining the interior pressure of said reactor at a low pressure.

38. The method of claim 33 further comprising monitoring through a window in a vacuum enclosure of the reactor light intensity during the step of cleaning, and terminating the step of cleaning whenever said intensity exhibits a predetermined signature.

39. The method of claim 38 wherein said predetermined signature is a temporary dip in said intensity by a threshold amount for a duration within a predetermined time range.

40. The method of claim 33 further comprising, during the step of processing the wafer, monitoring the output of an optical sensor that views the reactor interior through a window in a vacuum enclosure of the reactor light while maintaining an interior surface of said window free of light-blocking deposits, and determining from the sensor output the current thickness of a layer being processed on a wafer, and terminating the wafer process after the thickness reaches a predetermined amount.

41. The method of claim 40 wherein said step of processing is an etch process.

42. The method of claim 40 wherein said step of processing is a deposition process.

43. A method of cleaning a plasma reactor capable of processing a semiconductor wafer, said method comprising:
supplying a cleaning gas into said reactor, producing a high density inductively coupled RF plasma in the reactor and circulating the high density plasma within the chamber by inducing a magnetic field that circulates about the chamber at a low frequency.

44. The method of claim 43 further comprising monitoring through a window in a vacuum enclosure of the reactor light intensity during the step of cleaning while maintaining an interior surface of said window free of light-blocking deposits, and terminating the step of cleaning whenever said intensity exhibits a predetermined signature.

45. The method of claim 44 wherein said predetermined signature is a temporary dip in said intensity by a threshold amount for a duration within a predetermined time range.

46. A method of processing a semiconductor wafer in a plasma reactor, comprising:
supplying a process gas into said reactor, producing a high density inductively coupled RF plasma in the reactor and circulating the high density plasma within the chamber by inducing a magnetic field that circulates about the chamber at a low frequency.

47. The method of claim 46 further comprising applying an RF signal to a wafer support pedestal so as to control ion energy near the wafer surface.

48. The method of claim 46 wherein the process gas contains a polymer precuror species, and the method further includes selecting chamber parameters so that the reactor operates in an evaporation mode in which polymer is removed from interior chamber surfaces.

49. The method of claim 48 wherein said chamber parameters include at least one of: ion energy, chamber pressure, temperature of interior chamber surfaces.

50. The method of claim 48 further comprising, during the step of processing the wafer, monitoring the output of an optical sensor that views the reactor interior through a window in a vacuum enclosure of the reactor light while maintaining an interior surface of said window free of light-blocking deposits, and determining from the sensor output the current thickness of a layer being processed on a wafer, and terminating the wafer process after the thickness reaches a predetermined amount.

51. A method of operating a plasma reactor comprising:
processing a succession of wafers in a vacuum chamber of said reactor by providing a capacitively coupled plasma therein formed from a polymer precursor process gas while circulating the plasma using a magnetic field that rotates at a low frequency and while operating the reactor in a polymer evaporation mode to prevent polymer build-up on internal chamber surfaces;
periodically cleaning the interior of said chamber when not processing a wafer by a high density inductively coupled plasma formed from a chamber cleaning gas while circulating the high density plasma using a magnetic field that rotates at a low frequency.

52. The method of claim 51 further comprising:
during the processing of each wafer, monitoring the thickness of a particular layer on the wafer by an optical sensor viewing the wafer through a window in the enclosure of said vacuum chamber while said window is kept clear of polymer deposits by virtue of said reactor being operated in a polymer evaporation mode;
terminating the wafer process of the current wafer when the thickness reaches a predetermined thickness.

53. The method of claim 52 further comprising:
during the cleaning of the chamber, monitoring the optical intensity within said chamber by said optical sensor and terminating the cleaning step when said intensity exhibits a particular behavior.

54. The method of claim 53 wherein said particular behavior constitutes a temporary dip in said intensity.

55. A method of processing a a semiconductor wafer in a plasma reactor having a vacuum chamber for containing process gases and the semiconductor wafer, a capacitive RF power applicator having a pair of electrodes and a wafer support pedestal lying therebetween, said method comprising:
providing an inductive RF power applicator between said pair of electrodes having at least an aperture therein for permitting capacitive coupling between said pair of electrodes;
placing said semiconductor wafer onto said support pedestal; and
operating said capacitive and inductive power applicators simultaneously.
